(19) United States
(12) Patent Application Publication
(10) Pub. No.: US 2023/0301455 A1
(43) Pub. Date: Sep. 28, 2023

(54) SCREW SQUEEZER

(71) Applicant: Fuzhou Xinxin Industry Co., Ltd, Fuzhou (CN)

(72) Inventor: Shiqing Chen, Fuzhou (CN)

(21) Appl. No.: 17/725,543

(22) Filed: Apr. 20, 2022

(30) Foreign Application Priority Data
Mar. 24, 2022 (CN) 202220651105.3

(51) Int. Cl. A47J 19/02

(52) U.S. Cl. CPC A47J 19/025

(57) ABSTRACT

Disclosed is a screw squeezer comprising a pressing core column body, a pressure-bearing filter cup body and a juice collecting cup body, where spiral grooves are configured on the pressing core column body, protruding limiting blocks are arranged at the pressure-bearing filter cup body, and the pressure-bearing filter cup body is configured with several filter holes. The present disclosure processes ingredients into proper sizes, and places the processed ingredients into the pressure-bearing filter cup body, a pressing handle and a pressure-bearing handle are pushed and pressed in a direction close to each other, juice of the ingredients to be squeezed is separated out under a pressing action force of the pressing core column body, and leaks into the juice collecting cup body from the filter holes at the pressure-bearing filter cup body, and the juice collecting cup body is rotated and removed to obtain the squeezed juice.

### CROSS REFERENCE TO RELATED APPLICATIONS

The present application claims the benefit of Chinese Patent Application No. 202220651105.3 filed on Mar. 24, 2022, the contents of which are incorporated herein by reference in their entirety.

### TECHNICAL FIELD

The present disclosure belongs to the technical field of squeezers, and in particular relates to a screw squeezer.

### BACKGROUND ART

In the juice squeezing process of lemons, a juice squeezing device is required, the most common lemon juice squeezing approach in practices is that the lemons are cut and then directly gripped and pressed by hands. Though manual pressing is convenient and direct, it is obviously difficult to fully squeeze the lemons, and it is not hygienic by directly exposing objects to hands.

Therefore, the prior art disclosed a device for squeezing a lemon, for example, a utility model patent (Patent Application No.: CN201921363209.9) has disclosed “a lemon juice squeezing device capable of preventing splashing”, where a pressing block is arranged in a collection cylinder, and a threaded rod in threaded connection with a top end of the collection cylinder rotates to drive the pressing block to press downwards to squeeze for lemon juice. However, in practical operations, steps such as opening and filling are required to be sequentially performed for squeezing, making it tedious for use. Furthermore, the components are inconvenient to dismount for cleaning after use, which cannot fully satisfy the use requirements of people for high efficiency and convenience of appliances.

To solve the problems mentioned above, the present disclosure designs a screw squeezer.

### SUMMARY

In view of this, the present disclosure provides a screw squeezer, which may solve the problems above.

A screw squeezer includes a pressing core column body, a pressure-bearing filter cup body and a juice collecting cup body that may be vertically and sequentially sleeved, where spiral grooves are configured on a circumferential outer wall of the pressing core column body, protruding limiting blocks matching the spiral grooves are arranged at an upper end of a circumferential inner wall of the pressure-bearing filter cup body, a bottom of the pressure-bearing filter cup body is configured with several filter holes, and the pressing core column body may be screwed and pressed into an inner cavity of the pressure-bearing filter cup body by means of cooperation between the spiral grooves and the protruding limiting blocks, thereby enabling residue-liquid separation and squeezing on ingredients in the inner cavity of the pressure-bearing filter cup body.

Further, a top of the pressing core column body is configured with a core column limiting end edge, a side edge of the core column limiting end edge is connected to a pressing handle, the pressing handle includes a handle part and a pressing part matching each other, first reinforcing ribs being arranged inside the handle part and the pressing part, respectively, a diameter of the core column limiting end edge is greater than an outer diameter of the pressing core column body, a top of the pressure-bearing filter cup body is configured with a filter cup limiting end edge, a side edge of the filter cup limiting end edge is connected to a pressure-bearing handle, a diameter of the filter cup limiting end edge is greater than an outer diameter of the pressure-bearing filter cup body, and the pressure-bearing handle and the pressing handle are of the same structure.

Further, a height center position of the pressing handle corresponds to a position of a lower edge of the core column limiting end edge, and a height center position of the pressure-bearing handle corresponds to a position of an upper edge of the filter cup limiting end edge.

Further, a front end and a rear end of one side of the pressing handle towards the pressure-bearing handle are each configured with a pressing limiting boss, and a front end and a rear end of one side of the pressure-bearing handle towards the pressing handle are each configured with a pressure-bearing limiting boss.

Further, a magnet sheet is embedded into an end surface of the pressing limiting boss at a rear end of the pressing handle, and a magnetic attraction block is embedded into an end surface of the pressure-bearing limiting boss at a rear end of the pressure-bearing handle.

Further, a lower end of an outer wall of each of the pressure-bearing limiting bosses is configured with outer protruding buckle ridges, an upper end of an inner wall of the juice collecting cup body is configured with inner protruding buckle ridges, the several inner protruding buckle ridges and the several outer protruding buckle ridges are symmetrically distributed, the inner protruding buckle ridges are of an I-shaped structure, the outer protruding buckle ridges are in the form of arc sections, and the juice collecting cup body is detachably connected to a lower part of the pressure-bearing filter cup body by means of vertical buckling of the inner protruding buckle ridges and the outer protruding buckle ridges.

Further, the pressing core column body is of a cavity structure having an opening at a top, second reinforcing ribs are arranged on an inner cavity wall of the pressing core column body, and a sealing cover is arranged at a top of a cavity of the pressing core column body.

Further, handles are arranged on a left side and a right side of the juice collecting cup body, and cup mouths are arranged on a front side and a rear side of the juice collecting cup body, respectively.

Further, a side wall of the juice collecting cup body is configured with two liquid level scale marks located below the two cup mouths, and parts of the side wall of the juice collecting cup body corresponding to the two liquid level scale marks are of a transparent structure.

Further, the three spiral grooves are configured, the three protruding limiting blocks are arranged, the three spiral grooves are distributed in a circumferential array manner, the three protruding limiting blocks are distributed in a circumferential array manner, each of the protruding limiting blocks is obliquely arranged, and a bottom end of the pressing core column body is configured with an ellipsoid structure.

Compared with the prior art, the screw squeezer provided in the present disclosure rotates reversely the pressing core column body to be separated from the pressure-bearing filter cup body, processes ingredients to be squeezed into proper sizes, and then places the processed ingredients to be squeezed into the pressure-bearing filter cup body, the spiral grooves are aligned with the protruding limiting blocks, and the pressing handle and the pressure-bearing handle are pushed and pressed in a direction close to each other, such that the pressing core column body is screwed and pressed into the inner cavity of the pressure-bearing filter cup body by means of cooperation between the spiral grooves and the protruding limiting blocks, and performs residue-liquid separation and squeezing on the ingredients in the inner cavity, juice of the ingredients to be squeezed is separated out under a pressing action force of the pressing core column body, and leaks into the juice collecting cup body by means of the filter holes at the bottom of the pressure-bearing filter cup body, and the juice collecting cup body is rotated and removed to take the squeezed juice.

### BRIEF DESCRIPTION OF THE DRAWINGS

FIG. 1 is a structural schematic diagram of a combined screw squeezer provided in the present disclosure.

FIG. 2 is a structural schematic diagram of a detached screw squeezer.

FIG. 3 is an exploded structural schematic diagram of a pressing core column body in one direction.

FIG. 4 is an exploded structural schematic diagram of the pressing core column body in another direction.

FIG. 5 is an exploded structural schematic diagram of a pressure-bearing filter cup body in one direction.

FIG. 6 is an exploded structural schematic diagram of the pressure-bearing filter cup body in the other direction.

FIG. 7 is a structural schematic diagram of a juice collecting cup body.

### DETAILED DESCRIPTION OF THE EMBODIMENTS

The particular embodiment of the present disclosure is further described in detail below. It should be understood that the description of the embodiment of the present disclosure herein is not intended to limit the scope of protection of the present disclosure.

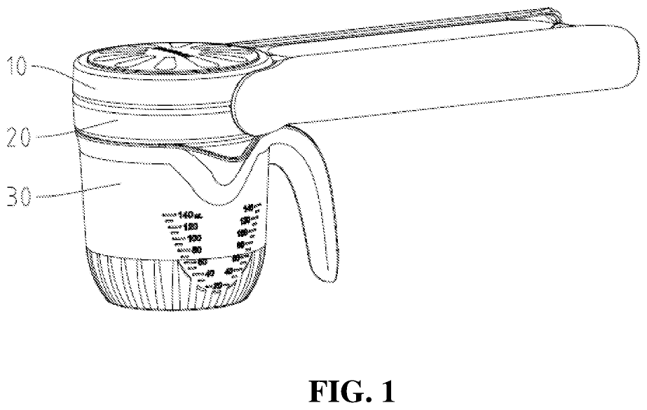

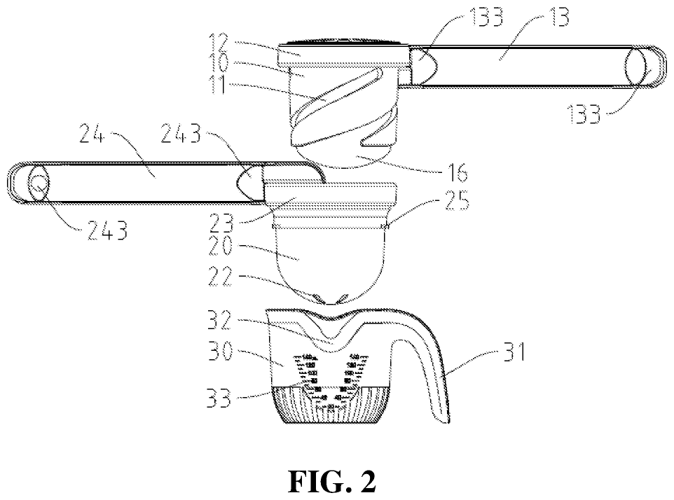

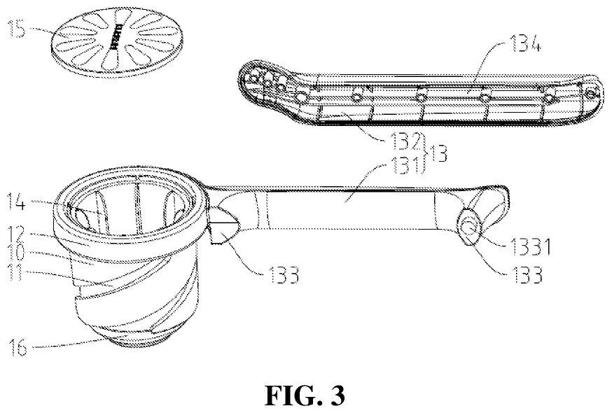

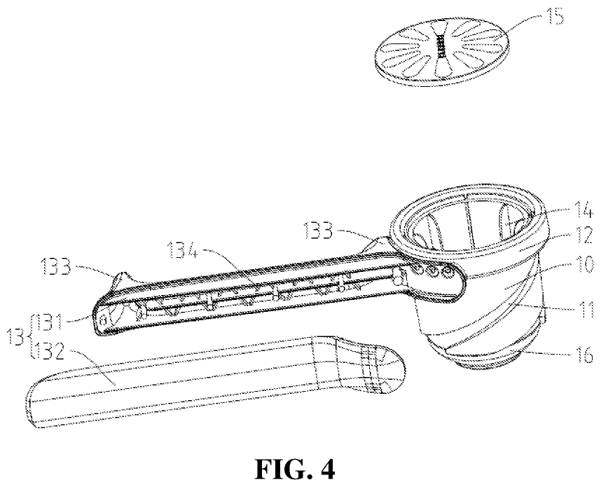

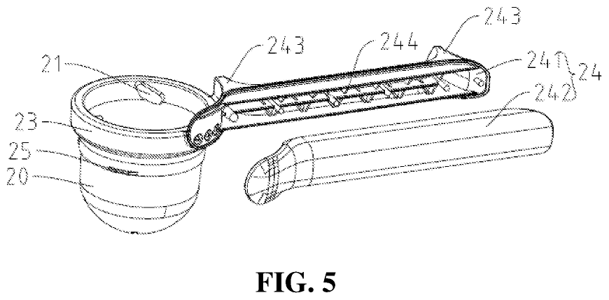

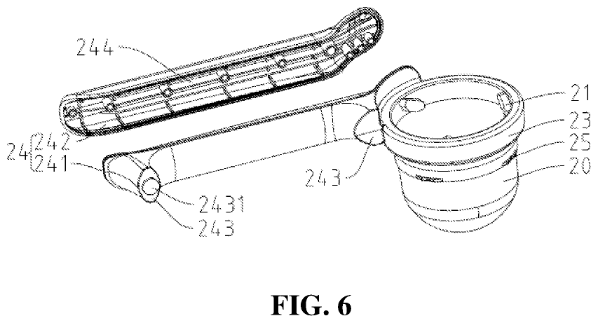

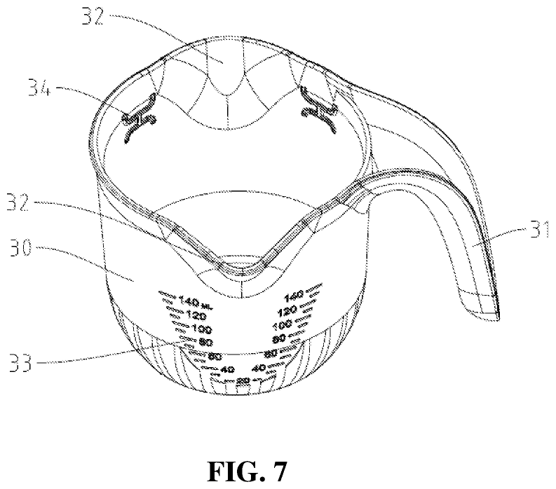

As shown in FIGS. 1-7, the figures illustrate a structural schematic diagram of a screw squeezer provided in the present disclosure. A screw squeezer includes a pressing core column body 10, a pressure-bearing filter cup body 20 and a juice collecting cup body 30 which may be vertically and sequentially sleeved, where spiral grooves 11 are configured on a circumferential outer wall of the pressing core column body 10, protruding limiting blocks 21 matching the spiral grooves 11 are arranged at an upper end of a circumferential inner wall of the pressure-bearing filter cup body 20, a bottom of the pressure-bearing filter cup body 20 is configured with several filter holes 22, and the pressing core column body 10 may be screwed and pressed into an inner cavity of the pressure-bearing filter cup body 20 by means of cooperation between the spiral grooves 11 and the protruding limiting blocks 21, so as to perform residue-liquid separation and squeezing on ingredients in the inner cavity of the pressure-bearing filter cup body 20. During use, the ingredients needing to be squeezed are put into the pressure-bearing filter cup body 20 in the squeezer, juice is separated out under a pressing action force of the pressing core column body 10 and leaks into the juice collecting cup body 30 by means of the filter holes 22 at the bottom of the pressure-bearing filter cup body 20 for use, the pressure-bearing filter cup body 20 is made of stainless steel and has preferable strength and durability, the rest structure may be made of non-metal materials of plastics, etc., and is light and easy to shape.

A top of the pressing core column body 10 is configured with a core column limiting end edge 12, a side edge of the core column limiting end edge 12 is connected to a pressing handle 13, the pressing handle 13 includes a handle part 131 and a pressing part 132 which match each other, first reinforcing ribs 134, 244 being arranged inside the handle part 131 and the pressing part 132 respectively, a diameter of the core column limiting end edge 12 is greater than an outer diameter of the pressing core column body 10, a top of the pressure-bearing filter cup body 20 is configured with a filter cup limiting end edge 23, a side edge of the filter cup limiting end edge 23 is connected to a pressure-bearing handle 24, a diameter of the filter cup limiting end edge 23 is greater than an outer diameter of the pressure-bearing filter cup body 20, and the pressure-bearing handle 24 and the pressing handle 13 are of the same structure. The core column limiting end edge 12 has a limiting effect after the pressure-bearing filter cup body 20 is sleeved with the pressing core column body 10, the filter cup limiting end edge 23 has a limiting effect after the juice collecting cup body 30 is sleeved with the pressure-bearing filter cup body 20, and a radial size of an outer wall of the core column limiting end edge 12 is consistent with that of an outer wall of the filter cup limiting end edge 23, such that after the pressing core column body 10 and the pressure-bearing filter cup body 20 are accommodated and sleeved, the appearance integrity is further improved; an axial direction of the pressing handle 13 is approximately tangent to a circumferential direction of the core column limiting end edge 12, an axial direction of the pressure-bearing handle 24 is approximately tangent to a circumferential direction of the filter cup limiting end edge 23, the pressing handle 13 and the pressure-bearing handle 24 serve as hand force application points during squeezing, and after the pressing core column body 10 is aligned with the pressure-bearing filter cup body 20, the pressing handle 13 and the pressure-bearing handle 24 are pushed and pressed in a direction close to each other, such that the pressing core column body 10 and the pressure-bearing filter cup body 20 are relatively and rotatably pressed, and a more labor-saving effect is achieved; and the staggered first reinforcing ribs 134, 244 are arranged inside the pressing handle 13 and the pressure-bearing handle 24, such that the pressing handle and the pressure-bearing handle have higher structural strength, and are more durable.

A height center position of the pressing handle 13 corresponds to a position of a lower edge of the core column limiting end edge 12, and a height center position of the pressure-bearing handle 24 corresponds to a position of an upper edge of the filter cup limiting end edge 23. After the pressing core column body 10 and the pressure-bearing filter cup body 20 are sleeved, the pressing handle 13 and the pressure-bearing handle 24 may be located on the same horizontal plane, such that force application and opposite pushing and pressing are facilitated.

A front end and a rear end of one side of the pressing handle 13 towards the pressure-bearing handle 24 are each configured with a pressing limiting boss 133, and a front end and a rear end of one side of the pressure-bearing handle 24 towards the pressing handle 13 are each configured with a pressure-bearing limiting boss 243, such that a touch limiting effect between the pressing handle 13 and the pressure-bearing handle 24 is achieved, when the pressing limiting bosses 133 make contact with the pressure-bearing limiting bosses 243, a certain gap is still reserved between the pressing handle 13 and the pressure-bearing handle 24, such that the pressing handle and the pressure-bearing handle are conveniently separated to rotate reversely after squeezing.

A magnet sheet 1331 is embedded into an end surface of the pressing limiting boss 133 at a rear end of the pressing handle 13, and a magnetic attraction block 2431 is embedded into an end surface of the pressure-bearing limiting boss 243 at a rear end of the pressure-bearing handle 24. The pressing handle 13 and the pressure-bearing handle 24 are both formed by splicing two half shell structures, such that the magnet sheet 1331 and the magnetic attraction block 2431 are conveniently loaded into the pressing handle and the pressure-bearing handle, and moreover, hollow structures of the pressing handle and the pressure-bearing handle make the whole screw squeezer lighter, thereby saving materials. When the squeezer is stored, the pressing core column body 10 and the pressure-bearing filter cup body 20 are in a completely sleeved rotation state, in such a case, the end surfaces of the pressing limiting bosses 133 make contact with the end surfaces of the pressure-bearing limiting bosses 243, and the pressing handle 13 and the pressure-bearing handle 24 are fixed together through a magnetic force generated by mutual attraction of the magnet sheet 1331 and the magnetic attraction block 2431, where connection modes of the pressing limiting bosses 133 and the pressure-bearing limiting bosses 243 are not limited to a magnetic attraction mode, and may be other modes, for example, a bonding buckle, a buckle, etc.

A lower end of an outer wall of each of the pressure-bearing limiting bosses 243 is configured with outer protruding buckle ridges 25, an upper end of an inner wall of the juice collecting cup body 30 is configured with inner protruding buckle ridges 34, the several inner protruding buckle ridges 34 and the several outer protruding buckle ridges 25 are symmetrically distributed, the inner protruding buckle ridges 34 are of an I-shaped structure, the outer protruding buckle ridges 25 are in the form of arc sections, and the juice collecting cup body 30 is detachably connected to a lower part of the pressure-bearing filter cup body 20 by means of vertical buckling of the inner protruding buckle ridges 34 and the outer protruding buckle ridges 25. During use, the juice collecting cup body 30 may be separated by directly pulling the juice collecting cup body downwards with a slight force, the juice collecting cup body may be directly pressed and buckled when combined and mounted anew, and during dismounting and mounting, the juice collecting cup body is dismounted and mounted by staggering the inner protruding buckle ridges 34 and the outer protruding buckle ridges 25 by means of rotation at a certain angle, and the juice collecting cup body is limited and fixed after the inner protruding buckle ridges 34 coincide with the outer protruding buckle ridges 25 by means of rotation by a certain angle, the advantage of which is that there is no problem of later loosening caused by frictional loss when the inner protruding buckle ridges 34 and the outer protruding buckle ridges 25 are dismounted.

The pressing core column body 10 is of a cavity structure having an opening at a top, second reinforcing ribs 14 are arranged on an inner cavity wall of the pressing core column body 10, and a sealing cover 15 is arranged at a top of a cavity of the pressing core column body 10. The cavity structures may reduce consumption of manufacturing materials, the second reinforcing ribs 14 function to improve the structural strength, the sealing cover 15 is used for sealing and blocking the cavity of the pressing core column body 10, and the sealing cover 15 may be detachably connected in a concealed buckle manner, such that the cavity of the pressing core column body 10 may be further used as a storage space, for example, the storage space is used for storing blocks to be squeezed in a short period of time.

Handles 31 are arranged on a left side and a right side of the juice collecting cup body 30, and cup mouths 32 are arranged on a front side and a rear side of the juice collecting cup body 30 respectively. The handle 31 facilitates taking and placing of the juice collecting cup body 30, and the two cup mouths 32 are used for pouring squeezed juice.

A side wall of the juice collecting cup body 30 is configured with two liquid level scale marks 33 located below the two cup mouths 32, and parts of the side wall of the juice collecting cup body 30 corresponding to the two liquid level scale marks 33 are of a transparent structure. By mean of the liquid level scale marks 33 of the transparent parts, the amount of the squeezed juice may be conveniently intuitive.

The three spiral grooves 11 are configured, the three protruding limiting blocks 21 are arranged, the three spiral grooves 11 are distributed in a circumferential array manner, the three protruding limiting blocks 21 are distributed in a circumferential array manner, each of the protruding limiting blocks 21 is obliquely arranged, and a bottom end of the pressing core column body 10 is configured with an ellipsoid structure 16. The three spiral grooves 11 and the three protruding limiting blocks 21 make synchronous contact and are stressed, on one hand, by increasing an effective stress surface, preferable and more uniform pressure bearing capacity is achieved, and on the other hand, a screw pitch (lead) of a thread structure may be increased under the same thread density, such that when the pressing core column body 10 and the pressure-bearing filter cup body 20 relatively rotate by a small angle, the pressing core column body 10 has an enough downward pressing stroke distance, and the ingredients to be squeezed are fully compressed and squeezed; and the protruding limiting blocks 21 are conveniently aligned with, and clamped into the spiral grooves 11 by the ellipsoid structure 16, thereby improving operability when the pressing core column body 10 and the pressure-bearing filter cup body 20 are combined and connected.

Compared with the prior art, the screw squeezer provided in the present disclosure rotates reversely the pressing core column body 10 to be separated from the pressure-bearing filter cup body 20, processes the ingredients to be squeezed into proper sizes, and then places the processed ingredients into the pressure-bearing filter cup body 20, the spiral grooves 11 are aligned with the protruding limiting blocks 21, and the pressing handle 13 and the pressure-bearing handle 24 are pushed and pressed in a direction close to each other, such that the pressing core column body 10 is screwed and pressed into the inner cavity of the pressure-bearing filter cup body 20 by means of cooperation between the spiral grooves 11 and the protruding limiting blocks 21, and carries out residue-liquid separation and squeezing on the ingredients in the inner cavity, juice of the ingredients to be squeezed is separated out under a pressing action force of the pressing core column body 10, and leaks into the juice collecting cup body 30 by means of the filter holes 22 at the bottom of the pressure-bearing filter cup body 20, and the juice collecting cup body 30 is rotated and removed to take the squeezed juice.

What is described above is merely a preferred embodiment of the present disclosure, but is not used to limit the scope of protection of the present disclosure, and any modifications, equivalent replacements, improvements, etc. within the spirit of the present disclosure all fall within the scope of the claims of the present disclosure.

What is claimed is:

1. A screw squeezer, comprising a pressing core column body, a pressure-bearing filter cup body and a juice collecting cup body which can be vertically and sequentially sleeved, wherein spiral grooves are configured on a circumferential outer wall of the pressing core column body, protruding limiting blocks matching the spiral grooves are arranged at an upper end of a circumferential inner wall of the pressure-bearing filter cup body, a bottom of the pressure-bearing filter cup body is configured with several filter holes, and the pressing core column body can be screwed and pressed into an inner cavity of the pressure-bearing filter cup body by means of cooperation between the spiral grooves and the protruding limiting blocks, so as to perform residue-liquid separation and squeezing on ingredients in the inner cavity of the pressure-bearing filter cup body.

2. The screw squeezer of claim 1, wherein a top of the pressing core column body is configured with a core column limiting end edge, a side edge of the core column limiting end edge is connected to a pressing handle, the pressing handle comprises a handle part and a pressing part which match each other, first reinforcing ribs being arranged inside the handle part and the pressing part respectively, a diameter of the core column limiting end edge is greater than an outer diameter of the pressing core column body, a top of the pressure-bearing filter cup body is configured with a filter cup limiting end edge, a side edge of the filter cup limiting end edge is connected to a pressure-bearing handle, a diameter of the filter cup limiting end edge is greater than an outer diameter of the pressure-bearing filter cup body, and the pressure-bearing handle and the pressing handle are of the same structure.

3. The screw squeezer of claim 2, wherein a height center position of the pressing handle corresponds to a position of a lower edge of the core column limiting end edge, and a height center position of the pressure-bearing handle corresponds to a position of an upper edge of the filter cup limiting end edge.

4. The screw squeezer of claim 2, wherein a front end and a rear end of one side of the pressing handle towards the pressure-bearing handle are each configured with a pressing limiting boss, and a front end and a rear end of one side of the pressure-bearing handle towards the pressing handle are each configured with a pressure-bearing limiting boss.

5. The screw squeezer of claim 4, wherein a magnet sheet is embedded into an end surface of the pressing limiting boss at a rear end of the pressing handle, and a magnetic attraction block is embedded into an end surface of the pressure-bearing limiting boss at a rear end of the pressure-bearing handle.

6. The screw squeezer of claim 4, wherein a lower end of an outer wall of each of the pressure-bearing limiting bosses is configured with outer protruding buckle ridges, an upper end of an inner wall of the juice collecting cup body is configured with inner protruding buckle ridges, the several inner protruding buckle ridges and the several outer protruding buckle ridges are symmetrically distributed, the inner protruding buckle ridges are of an I-shaped structure, the outer protruding buckle ridges are in the form of arc sections, and the juice collecting cup body is detachably connected to a lower part of the pressure-bearing filter cup body by means of vertical buckling of the inner protruding buckle ridges and the outer protruding buckle ridges.

7. The screw squeezer of claim 1, wherein the pressing core column body is of a cavity structure having an opening at a top, second reinforcing ribs are arranged on an inner cavity wall of the pressing core column body, and a sealing cover is arranged at a top of a cavity of the pressing core column body.

8. The screw squeezer of claim 1, wherein handles are arranged on a left side and a right side of the juice collecting cup body, and cup mouths are arranged on a front side and a rear side of the juice collecting cup body respectively.

9. The screw squeezer of claim 8, wherein a side wall of the juice collecting cup body is configured with two liquid level scale marks located below the two cup mouths, and parts of the side wall of the juice collecting cup body corresponding to the two liquid level scale marks are of a transparent structure.

10. The screw squeezer of claim 1, wherein the three spiral grooves are configured, the three protruding limiting blocks are arranged, the three spiral grooves are distributed in a circumferential array manner, the three protruding limiting blocks are distributed in a circumferential array manner, each of the protruding limiting blocks is obliquely arranged, and a bottom end of the pressing core column body is configured with an ellipsoid structure.
